(19) United States
(12) Patent Application Publication
(10) Pub. No.: US 2021/0089959 A1
(43) Pub. Date: Mar. 25, 2021

(54) SYSTEM AND METHOD FOR ASSISTING CUSTOMER SUPPORT AGENTS USING A CONTEXTUAL BANDIT BASED DECISION SUPPORT SYSTEM

(71) Applicant: Intuit Inc., Mountain View, CA (US)

(72) Inventors: Mithun GHOSH, Bangalore (IN); Aminish SHARMA, Bangalore (IN); Shashi ROSHAN, Bangalore (IN); Hrishikesh GANU, Bangalore (IN)

(73) Assignee: Intuit Inc., Mountain View, CA (US)

(21) Appl. No.: 16/582,208

(22) Filed: Sep. 25, 2019

(51) Int. Cl. G06N 20/00; G06Q 30/00; G06F 16/953

(52) U.S. Cl. CPC G06N 20/00; G06F 16/953; G06Q 30/016

(57) ABSTRACT

A server may receive an inquiry associated with an interaction between a customer and a customer support agent from a device associated with a customer support agent; enter the inquiry as an input to a contextual bandit model; select, using the contextual bandit model, a collection of articles from a plurality of pre-defined collections of articles based on the inquiry; cause, in response to the contextual bandit model selecting the collection of articles, at least one search result to be displayed on a user interface of the device associated with the customer support agent, wherein a search result includes at least a portion of at least one article of the collection of articles; cause text within the at least one search result to be highlighted; receive feedback on the collection of articles from the customer support agent; and update the contextual bandit model based on the feedback.

### BACKGROUND OF THE DISCLOSURE

Many modern organizations and corporations offer versatile and extensive product offerings to a large customer base, often consisting of millions of people. Because of the extensiveness of modern customer bases, Customer Support Agents (CSA's) and, more generally, customer service departments, receive large volumes of customer inquiries for assistance, both by telephone and webchat. In general, the overall goal for a CSA interacting with a customer seeking assistance is to provide a quick and correct resolution to their inquiries. An improved end user experience during support is generally linked with a satisfied customer base.

During webchat customer support interactions, the chat typically starts with a customer typing in their inquiry or problem. A CSA will receive the message in the webchat and attempt to solve the problem or answer the question using a combination of their own domain knowledge and searching through a knowledge database that contains documents about usage and troubleshooting. The webchat often goes into several rounds of messages back and forth between the customer and the CSA before a solution or answer is achieved. This same procedure typically happens with telephone calls with customer support, as well.

There have been attempts at using question-answering systems and models designed to help CSA's come across a solution quicker, both for webchat and telephone calls. Many companies do, in fact, have detailed models that can help CSA's come across correct answers or solutions based on a question. However, these models are not able to be effectively accessed in a timely fashion by CSA's in real-time. Furthermore, some attempted solutions have been developed to employ machine learning models that can select a question-answering model to be used. These are typically developed in a supervised learning fashion and are optimized for metrics that do not directly benefit the CSA. Furthermore, CSA's generally do not have time to give supervised feedback to a model in order for it to learn more effectively.

In addition, traditional search techniques involve federated searches (i.e. searching multiple collections or resources in parallel). However, relevant search results are often determined by comparing search inquiries to labels on the resources or collections. These labels are created by third parties and may not accurately reflect what a customer or customer support agent would feel is a relevant search result.

### BRIEF DESCRIPTION OF THE FIGURES

FIG. 1 is a block diagram of an example system for assisting customer support agents using a contextual bandit based decision support system, according to an embodiment of the present disclosure.

FIG. 2 is a flow diagram showing processing that may occur within the system of FIG. 1, according to an embodiment of the present disclosure.

FIG. 3 is a flow diagram showing processing that may occur within the system of FIG. 1, according to an embodiment of the present disclosure.

FIG. 4 is an example graphical user interface (GUI), according to an embodiment of the present disclosure.

FIG. 5 shows an example server device, according to an embodiment of the present disclosure.

FIG. 6 shows an example computing device, according to an embodiment of the present disclosure.

### DETAILED DESCRIPTION OF SEVERAL EMBODIMENTS

Embodiments of the present disclosure relate to systems and methods for generating improved search results using a contextual bandit model. This method may be used to leverage contextual bandit algorithms in a real-world system by interacting with and receiving feedback from customer support agents (CSA's). Contextual bandit algorithms are a class of machine learning algorithms that utilize contextual information and partial feedback to continually learn and determine the model out of a plurality of models that will most likely contribute to success. In an example embodiment, there may be a pre-determined number of collections of articles within a knowledge base. Each collection may have multiple articles that reflect different frameworks for answering questions or different topics. For example, QuickBooks® Online has a large collection of tutorials and documentation to help customers navigate the software. When a webchat is initiated between a customer and a CSA, the customer may ask a question or describe a problem they are having. The contextual bandit model, herein referred to as the CB model, may use the chat history of the customer and/or the inquiry of the customer to select one of the collections, and search within that collection. Choosing a single collection of articles, rather than performing a federated search across all collections of articles, may decrease system latency. Based on the selected collection, the CB model may output a list of search results to the CSA. Each search result may reflect a different collection and may show a portion of an article within that collection with the most relevant text highlighted. The search results may be displayed in an order reflecting their relevance, with the most relevant collection being displayed first. The CSA may choose a search result and send it, or send part of it, to the customer. The CSA may also decide that none of the results are relevant and send their own message to the customer. The CSA may rate the answer given to them by the CB model on a numerical scale to reflect positive or negative feedback on the answer. The CB model may take the feedback and use it to update the weights of the models, i.e. learn how often and when to select a certain model based on the context.

Through this methodology, the CB model may continuously learn in an online fashion how to provide suggestions to CSA's to increase their productivity. This may be referred to a human-in-the-loop system, where a machine learning model is used to offer recommendations, a human makes the final call on whether the recommendation is implemented, and the machine learning model uses whether the human uses the suggestion or not to make better suggestions. In addition,

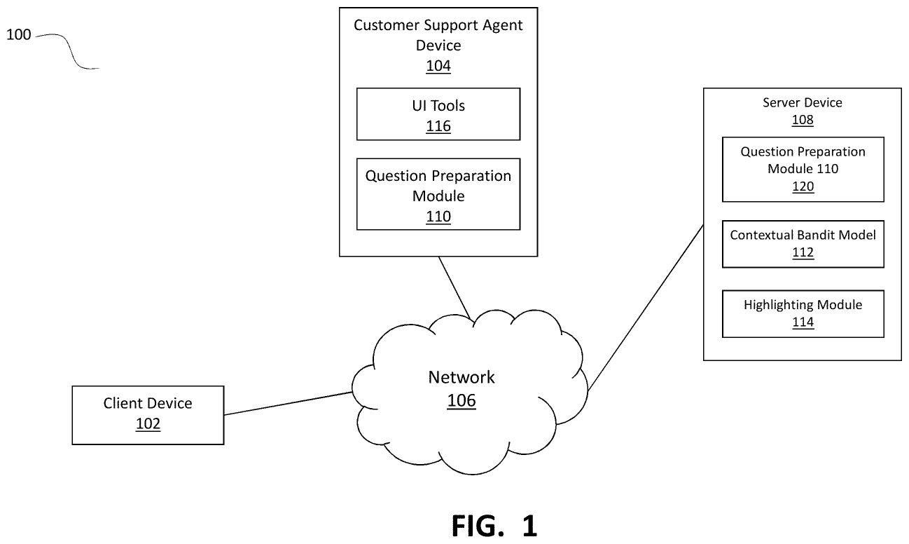

FIG. 1 is a block diagram of an example system 100 for assisting customer support agents using a contextual bandit based decision support system, according to an embodiment of the present disclosure. System 100 may include a client device 102, a customer support agent device 104, and server device 108, all of which may be communicably coupled via network 106. In some embodiments, some or all components of system 100 may be run on Amazon Elastic Compute Cloud. In some embodiments, system 100 may include any number of customer support agent devices and associated client devices. For example, for a large organization, there may be as many as 100, 1,000, or more customer support agent devices communicating with client devices. This may represent a large team of customer support agents communicating with a large customer base. Network 106 may be configured to handle all traffic, and server device 108 may be configured to receive feedback and send instructions to display search results to any plurality of customer support agent devices.

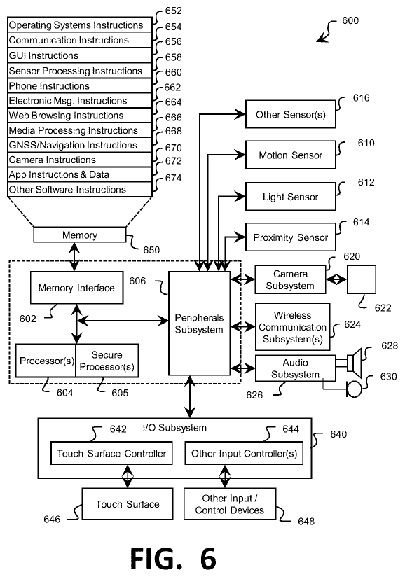

A client device 102 can include one or more computing devices capable of receiving user input as well as transmitting and/or receiving data via network 106 or communicating with server device 108 and/or customer support agent device 104. In some embodiments, a client device 102 can include a conventional computer system, such as a desktop or laptop computer. Alternatively, a client device 102 may include a device having computer functionality, such as a personal digital assistant (PDA), a mobile telephone, a smartphone, or other suitable device. In some embodiments, a client device 102 may be the same as or similar to user device 600 described below in the context of FIG. 6.

In some embodiments, a client device 102 may be associated with a customer seeking support from a customer support agent of an organization. A client device 102 may be configured to allow a customer to communicate with a customer support agent via a chat interface.

As shown in FIG. 1, a customer support agent device 104 may include UI tools 116 and question preparation module 110. A customer support agent device 104 may include one or more computing devices capable of receiving user input as well as transmitting and/or receiving data via network 106 or communicating with server device 108 and/or a client device 102. In some embodiments, a customer support agent device 104 may include a conventional computer system, such as a desktop or laptop computer. Alternatively, a customer support agent device 104 may include a device having computer functionality, such as a personal digital assistant (PDA), a mobile telephone, a smartphone, or other suitable device. In some embodiments, a customer support agent device 104 may be the same as or similar to user device 600 described below in the context of FIG. 6.

In some embodiments, a customer support agent device 104 may be associated with a customer support agent and may allow a customer support agent to communicate with a customer seeking support via a chat interface with UI tools 116. A customer support agent device 104 may be configured to receive inquiries from a client device 102 and send received inquiries to server device 108 via network 106. In some embodiments, a customer support agent device 104 may be configured to send an entire chat history to server device 108 via network 106. A customer support agent device 104 may be configured to receive instructions from server device 108 to display search results on a user interface. In some embodiments, the user interface may be Angular JS. In some embodiments, UI tools 116 may provide functionality to a customer support agent to compose a message to send to a client device 102. In some embodiments, UI tools 116 may allow the customer support agent to type in free form text, copy and paste text from the displayed search results, or a combination of the two. In some embodiments, UI tools 116 may provide functionality for the customer support agent to save a composed message.

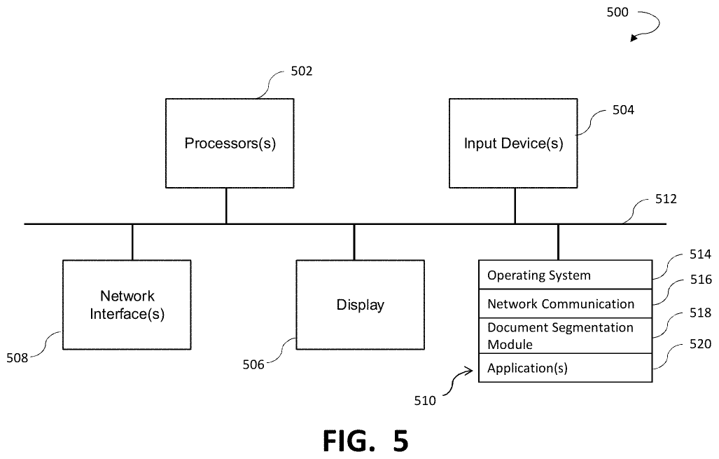

Server device 108 may include any combination of one or more of web servers, mainframe computers, general-purpose computers, personal computers, or other types of computing devices. Server device 108 may represent distributed servers that may be remotely located and communicate over a communications network, and/or over a dedicated network such as a local area network (LAN). Server device 108 may also include one or more back-end servers for carrying out one or more aspects of the present disclosure. In some embodiments, server device 108 may be the same as or similar to device 500 described below in the context of FIG. 5.

As shown in FIG. 1, server device 108 may include question preparation module 110, contextual bandit model 112, and highlighting module 114. Server device 108 may be configured to receive an inquiry from the customer support agent device 104 after it has been sent by a client device 102. Server device 108 may be configured to then enter the inquiry as an input to contextual bandit model 112. Server device 108 may be configured to send instructions to display search results determined by contextual bandit model 112 to a customer support agent device 104. In some embodiments, server device 108 may be configured to receive feedback from a customer support agent device 104. In some embodiments, server device 108 may be configured to record the actions taken by a customer support agent on customer support agent device 104 in response to receiving instructions to display search results. In some embodiments, server device 108 may be configured to associate recorded actions with feedback to send to contextual bandit model 112. Server device 108 may be configured to give the received feedback to contextual bandit model 112 for the model to be updated based on the feedback. In some embodiments, server device 108 may send instructions or cause the customer support agent device 104 to display search results in an order of relevance to the inquiry. In some embodiments, server device 108 may use or operate on AWS Lambda.

In some embodiments, question preparation module 110 may be configured to map an inquiry or textual phrase to an embedding in real coordinate space. In some embodiments, question preparation module 110 may map a word or series of words to a vector representation of real numbers, such as in Word2vec. Question preparation module 110 may be configured to perform any method of word embedding or language modeling as used in natural language processing. In some embodiments, question preparation module 110 may use a skip-gram architecture or skip-gram algorithm, as described in Tomas Mikolov, Kai Chen, Greg Corrado: “Efficient Estimation of Word Representations in Vector Space”, 2013; [http://arxiv.org/abs/1301.3781 arXiv:1301.3781], the entirety of which is herein incorporated by reference. A skip-gram algorithm may use a word to predict words immediately surrounding it to represent a phrase of text. In some embodiments, question preparation module 110 may be configured to send an embedding (e.g. a word or series of words represented as vectors) as context, or an input, to contextual bandit model 112. Question preparation module 110 may operate either in a customer support agent device 104 or in a server device 108.

Contextual bandit model 112 may include a contextual bandit algorithm. In some embodiments, contextual bandit model 112 may receive an inquiry as an input for context. In some embodiments, the inquiry may be received from question preparation module 110 in vector representation. In some embodiments, the contextual bandit algorithm may be configured to select collection of articles from a knowledge base. The knowledge base may include a plurality of collections. Each collection may include multiple articles of text, may be focused on a particular topic, and/or may be focused on a specific framework for addressing customer questions. In some embodiments, these collections may have been created by different customer service or technical assistance departments. The contextual bandit algorithm may be configured to select a collection based on the inquiry, rather than performing a federated search (i.e. searching multiple collections in parallel) across numerous different collections. The contextual bandit algorithm may be configured to select a collection that it predicts will yield the highest probability of success for the customer support agent, meaning yield the most relevant answer to the question or problem in the received inquiry. In some embodiments, contextual bandit model 112 may be configured to send a selected collection to highlighting module 114. The contextual bandit model 112 may be configured to receive feedback on its selections and continuously learn and update the weights of the model, where the weights reflect how often and when each collection should be selected, based on the context. In some embodiments, contextual bandit model 112 may be configured to perform an exploration selection at a pre-determined frequency or probability (e.g. select a random collection 10% of the time, as opposed to selecting the “best” collection). For example, after every 9 selections made based on attempting to select the best collection for the customer support agent, contextual bandit model 112 may be configured to select a random collection that may not be the “best” collection and use the resulting feedback to further update the weights of the algorithm. In some embodiments, contextual bandit model 112 may be configured to select a collection based on the chat history of the customer and customer support agent.

In some embodiments, in response to contextual bandit model 112 selecting a collection of articles, server device 108 may send instructions to a customer support agent device 104 to display at least a portion of one or more articles from the selected collection of articles. In some embodiments, server device may cause multiple collections to be displayed in an order of relevance, wherein the order is determined by a relevance score calculated by contextual bandit model 112. In some embodiments, the contextual bandit model may maintain an associated probability distribution for each collection of articles, where the distribution reflects the probability that an article will be relevant. The relevance score may reflect the internally maintained probability that an article is relevant to an inquiry; a high score may be associated with a high probability. The probability distribution may be updated whenever the contextual bandit model receives feedbacks and updates itself.

In some embodiments, highlighting module 114 may be configured to receive a selected collection of articles from contextual bandit model 112. In some embodiments, highlighting module 114 may be configured to highlight relevant text within at least one article within the selected collection of articles. In some embodiments, highlighting module 114 may determine text to be highlighted using machine learning algorithms. In some embodiments, highlighting module 114 may use a Latent Dirichlet Allocation model to determine text to be highlighted. In some embodiments, highlighting module 114 may use a Siamese network binary classifier to determine text to be highlighted. In some embodiments, highlighting module 114 may use or operate on Amazon Elastic Compute Cloud.

Network 106 may include one or more wide areas networks (WANs), metropolitan area networks (MANs), local area networks (LANs), personal area networks (PANs), or any combination of these networks. Network 106 may include a combination of one or more types of networks, such as Internet, intranet, Ethernet, twisted-pair, coaxial cable, fiber optic, cellular, satellite, IEEE 801.11, terrestrial, and/or other types of wired or wireless networks. Network 106 can also use standard communication technologies and/or protocols.

The various system components—such as modules 110 through 114—may be implemented using hardware and/or software configured to perform and execute the processes, steps, or other functionality in conjunction therewith.

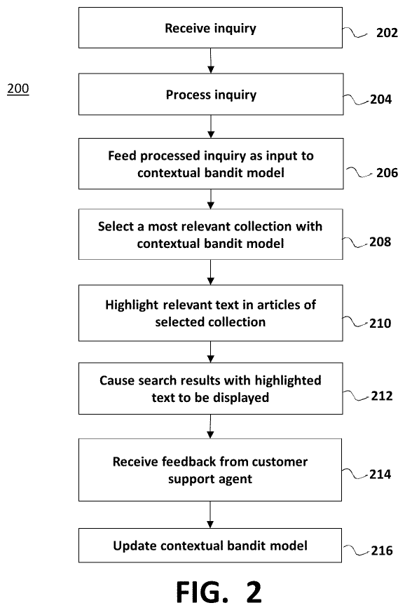

FIG. 2 is a flow diagram showing a process 200 that may occur within the system of FIG. 1, according to some embodiments of the present disclosure. At block 202, server device 108 may receive an inquiry. The inquiry may be a question or statement of an issue sent by a customer to a customer support agent. In some embodiments, an inquiry may be received from a telephone conversation; for example, by using a speech-to-text transcription of a telephone call. In relation to system 100, the inquiry may be sent to a customer support agent device 104 from a client device 102, and server device 108 may then receive the inquiry from a customer support agent device 104. In some embodiments, this may be done automatically; for example, server device 108 may record all messages in a conversation between a customer support agent and a customer. In some embodiments, this may be done manually, e.g. the customer support agent must submit the inquiry to server device 108. In some embodiments, server device 108 may also receive a full chat history between a customer and customer support agent from a customer support agent device 104. At block 204, question preparation module 110 may process the received inquiry. In some embodiments, the inquiry may be mapped to an embedding within an n dimensional real coordinate space as a vector representation in order to be fed as an input or context to the contextual bandit algorithm, as described in relation to question preparation module 110 in the context of FIG. 1.

At block 206, question preparation module may feed the processed inquiry into a contextual bandit algorithm as an input or context. In some embodiments, contextual bandit algorithm may be included in contextual bandit model 112 of system 100. At block 208, contextual bandit model 112 may select a most relevant collection with a contextual bandit algorithm. The contextual bandit algorithm may utilize a reward distribution over the possible collections; meaning the algorithm, based on the input inquiry, determines a collection that will yield the highest reward based on the context or input. In some embodiments, a reward may be tied to the success or relevance of the selected collection of articles, i.e. if the selected collection is helpful for the customer support agent it will receive a high reward. Further details will be discussed on rewards in relation to block 214.

At block 210, highlighting module 114 highlight relevant text in one or more articles of the selected collection of articles. In some embodiments, the text to be highlighted may be determined with a Latent Dirichlet Allocation model, similar to or the same as described in Matthew D. Hoffman, David M. Blei, and Francis Bach. 2010. “Online learning for Latent Dirichlet Allocation. In Proceedings of the 23rd International Conference on Neural Information Processing Systems”—Volume 1 (NIPS'10), J. D. Lafferty, C. K. I. Williams, J. Shawe-Taylor, R. S. Zemel, and A. Culotta (Eds.), Vol. 1. Curran Associates Inc., USA, 856-864, the entirety of which is herein incorporated by reference. Latent Dirichlet Allocation is a standard machine learning technique that may employ a Bayesian probabilistic model of text documents. Latent Dirichlet Allocation may determine a structure of topics by probabilistically factorizing a matrix of word counts (i.e. the number of times a word appears in each document) into a matrix of topics and the topics' associated weights. In other words, each word of a document may be assigned to a particular topic. The Latent Dirichlet Allocation model may be trained on a large number of Customer Support articles and User Manuals, both of which may be included in collections of articles in the knowledge base. The model may be trained to match the inquiry to a specific article and choose sentences or phrases within the article that are relevant to the inquiry and highlight them. In some embodiments, a word distribution may be employed to determine relevance.

In some embodiments, the text to be highlighted may be determined using a Siamese network binary classifier. In some embodiments, a Siamese classifier may be a Siamese neural network, a standard machine learning architecture. This network may be trained on a dataset of known questions and answers, i.e. a segment of text that is identified as a question and a segment of text that is known to be the answer. The network, given an input question (for example, the inquiry received from the customer support agent device), may analyze each sentence of text within the selected article and may output a “yes” or a “no”. This may indicate that the model deems the sentence to be an answer to the question. In some embodiments, if a portion of text is classified as a “yes”, that section of text may be selected for highlighting.

At block 212, server device 108 may cause search results with highlighted text to be displayed on a user interface of a device associated with the customer support agent. In some embodiments, this may be customer support agent device 104 of system 100. In some embodiments, each search result may display an article from a different collection. The first displayed search result may be the collection selected to be the most relevant by the contextual bandit algorithm. In some embodiments, multiple search results may be displayed in an order corresponding to relevance. In some embodiments, this may be based on a relevance score. Each article may have at least one sentence, phrase, or portion of text highlighted. In some embodiments, server device 108 may send instructions to customer support agent device 104 and customer support agent device 104 may use the instructions to display the search results on a user interface.

At block 214, server device 108 may receive feedback from customer support agent. In some embodiments, server device 108 may receive feedback from a customer support agent in response to sending instructions to display one or more collections of articles selected by the contextual bandit model. In some embodiments, the feedback may be received from customer support agent device 104. In some embodiments, feedback may be scalar or discretized, such as numbers on a numerical scale (1/2/3) or excellent/good/bad. In some embodiments, the numbers or descriptions may reflect the level of success of the provided search results by the contextual bandit model. The levels of success may correspond to levels of rewards within the contextual bandit model; for example, excellent/3 may correspond to a high reward, good/2 may correspond to a medium reward, and bad/1 may correspond to a low reward. In some embodiments, any number of reward levels may be used, for example 5 or 10. The contextual bandit model may employ a reward distribution and may be trained to maximize rewards with its selections. For example, in response to receiving an inquiry, the model may use weights for every possible collection of articles that reflect the likelihood that each collection will yield a high reward if chosen for the given inquiry.

In some embodiments, feedback may be received explicitly from a customer support agent. For example, after receiving search results from the contextual bandit model, the customer support agent may select, via a user interface, a rating for the displayed search result. In some embodiments, this rating may either be a 1/2/3 or excellent/good/bad, as discussed above. In some embodiments, feedback may be received implicitly from a customer support agent. For example, server device 108 may be configured to record all actions of a customer support agent on customer support agent device 104. For example, if server device 108 records the customer support agent send a search result directly to a customer without modifying it, server device 108 may record this as a high reward. If server device 108 records the customer support agent send only part of a search result to a customer and add modifications to the answer, server device 108 may record this as a medium reward. If server device 108 records the customer support agent chooses to not send any search result to the customer and only add in their own text, server device 108 may record this as a low reward.

At block 216, service device 108 may update the contextual bandit model. In some embodiments, the feedback received from the customer support agent, whether implicitly or explicitly, may be used to continuously train the contextual bandit algorithm. In some embodiments, server device 108 may receive feedback in real-time from a large plurality of customer support agents and update the contextual bandit model. In some embodiments, contextual bandit model 108 may update itself through a learning process.

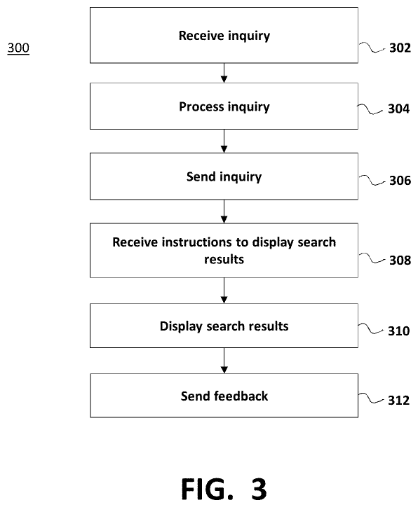

FIG. 3 is a flow diagram showing process 300 that may occur within the system of FIG. 1, according to an embodiment of the present disclosure. In some embodiments, a device associated with a customer support agent may perform process 300, possibly when they are in communication via webchat with a customer seeking assistance. In relation to system 100, customer support agent device 104 may perform process 300. At block 302 a device may receive an inquiry. For example, a device associated with a customer support agent may receive an inquiry from a customer via webchat. In some embodiments, the inquiry may be received via phone call and transcribed from speech to text. In some embodiments, customer support agent device 104 may receive the inquiry from a customer. At block 304, question preparation module 110 may process the inquiry. In some embodiments, question preparation module 110 may map the word or series of words to a vector representation. In some embodiments, question preparation module 110 may use a skip-gram algorithm, as described in relation to FIG. 1.

At block 306, customer support agent device 104 may send inquiry. In some embodiments, a customer support agent device may send an inquiry to a server for processing (e.g. server device 108). In some embodiments, this inquiry may be a message, question, or problem sent to the customer support agent by a customer. At block 308, customer support agent device 104 may receive instruction to display results. In some embodiments, instructions may be received from server device 108. In some embodiments, server device 108 may include a contextual bandit model 112 and each search result may correspond to a collections of article selected by the contextual bandit model 112. In some embodiments, the contextual bandit model 112 may be configured to make selections based on maximizing rewards, as described in relation to FIG. 2. In some embodiments, customer support agent device may also receive instructions to display search results with highlighted text or phrases. The text to be highlighted may be determined by highlighting module 114 in system 100 and may be particularly relevant to the received inquiry. For example, if the inquiry asks “how do I change my password?”, a highlighted phrase within the article displayed as a search result may be “go into settings and click ‘change my password.’”

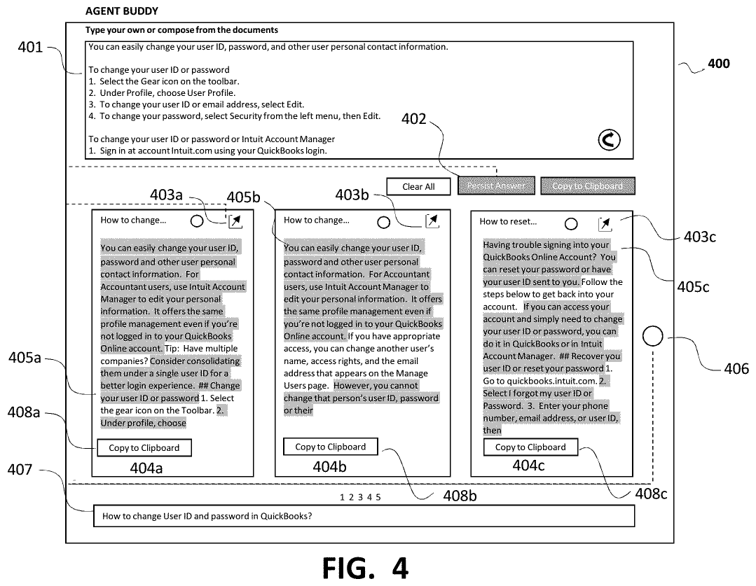

At block 310, based on the instructions received, customer support agent device 104 may display search results. In some embodiments, the displaying of search results may be performed on a user interface such as in FIG. 4. The user interface may also operate with UI tools 116 of system 100. At block 312, customer support agent device 104 may send feedback. In some embodiments, customer support agent device 104 may send feedback to server device 108. In some embodiments, sending feedback may either be implicit or explicit. In an embodiment of implicit feedback, the actions of a user (e.g. customer support agent) may be recorded while utilizing the user interface that displays the search results. Specific actions may correspond to different levels of rewards, as described in relation to block 214 of FIG. 2. In an embodiment of explicit feedback, the user interface that displays the search results may provide functionality for the user to submit feedback, such as described in relation to block 214 of FIG. 2.

FIG. 4 is an example graphical user interface (GUI), according to an embodiment of the present disclosure. In some embodiments, GUI 400 may be or may be controlled by UI tools 116 of system 100 and may be displayed on a customer support agent device, such as customer support agent device 104. GUI 400 may include a compose answer option 401, a persist answer option 402, a show full document option 403a, 403b, . . . , 403c (403 generally), search results 404a, 404b, . . . , 404c (404 generally), highlighted text 405a, 405b, . . . , 405c (405 generally), navigation button 406, search bar 407, and a copy to clipboard option 408a, 408b, . . . , 408c (408 generally). In some embodiments, actions performed on GUI 400 may be recorded by a server device, for example server device 108 of system 100, associated with different levels of rewards, and provided to a contextual bandit model. In some embodiments, the user of GUI 400 may be a customer support agent.

In some embodiments, a compose answer option 401 may provide functionality for a user to compose a message. For example, a customer support agent may compose a message to send to a client device associated with a customer as answer to a customer inquiry received via webchat. In some embodiments, a user may be able to type free form text into compose answer option 401. In some embodiments, a user may be able to copy text from search results 404 into compose answer option 401. In some embodiments, a user may be able to compose a message with both free form text and text copied from a search result 404. In some embodiments, a user of GUI 400 may use a persist answer option 402 to save an answer composed with compose answer option 401. This may allow the user to use this message again in the future. For example, if a customer support agent composes an effective and helpful message to a customer inquiry, the customer support agent may save the message, allowing them to send the same message again in response to a future customer inquiry.

In some embodiments, a show full document option 403 may provide functionality for a user to view an entire document or article. In some embodiments, this option may allow the user to view the document in a new window. In some embodiments, the user may be able to zoom and copy text in the new window. In some embodiments, GUI 400 may display a list of search results 404. Each search result may be derived from a different collection of articles or documents. In some embodiments, the search results 404 may be selected by a contextual bandit model using an inquiry to analyze all possible collections and their likelihood of providing a successful answer. In some embodiments, this contextual bandit model may be the contextual bandit model 112 of system 100 and the search results may be caused to display on customer support agent device 104 by server 108. In some embodiments, the search results may be displayed in an order corresponding to their relevance to the inquiry, for example their relevance scored as maintained by the contextual bandit model. In some embodiments, the portion of the article to be displayed may be the portion of the article with the most amount of highlighted phrases. For example, if a customer asks how to change their user ID and password in QuickBooks®, each search result may show an article or portion of an article with information on changing an ID and password, with the most relevant displayed first in the list.

In some embodiments, search results 404 may include highlighted text 405. In some embodiments, the highlighted text 405 is determined by highlighting module 114 of system 100. In some embodiments, the highlighted text may be the most relevant parts of the search results 404. This may allow a user to quickly and easily identify answers to received inquiries. In some embodiments, GUI 400 may include a navigation button 406 to navigate through the list of search results 404. For example, when a user presses the navigation button 406, the next page of search results may be displayed.

In some embodiments, search bar 407 may provide functionality for a user to search a question or inquiry. In some embodiments, this may be an inquiry received by customer support agent device 104 from a client device 102 associated with a customer. For example, in a webchat interaction between a customer support agent and a customer, a customer may send a question or inquiry to the customer support agent. The customer support agent, who may also be using GUI 400, may insert the received inquiry into search bar 407. This may send the inquiry to a server device (e.g. server device 108 of system 100), which may initiate process 200. A contextual bandit model may select a collection based on the inquiry and the search results reflecting an article or articles from the collection may be displayed as search results 404.

In some embodiments, a copy to clipboard button 408 may provide functionality for a user to copy an entire article to a clipboard, and may allow them to paste the article in the compose answer option 401. In some embodiments, this may copy the entire article to the clipboard, not just what is visible on GUI 400.

FIG. 5 is a diagram of an example server device 500 that may be used within system 100 of FIG. 1. Server device 500 may implement various features and processes as described herein. Server device 500 may be implemented on any electronic device that runs software applications derived from complied instructions, including without limitation personal computers, servers, smart phones, media players, electronic tablets, game consoles, email devices, etc. In some implementations, server device 500 may include one or more processors 502, volatile memory 504, non-volatile memory 506, and one or more peripherals 508. These components may be interconnected by one or more computer buses 510 and/or, in the case of a distributed computing system, one or more networks.

Processor(s) 502 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Bus 510 may be any known internal or external bus technology, including but not limited to ISA, EISA, PCI, PCI Express, NuBus, USB, Serial ATA, or FireWire. Volatile memory 504 may include, for example, SDRAM. Processor 502 may receive instructions and data from a read-only memory or a random access memory or both. Essential elements of a computer may include a processor for executing instructions and one or more memories for storing instructions and data.

Non-volatile memory 506 may include by way of example semiconductor memory devices, such as EPROM, EEPROM, and flash memory devices; magnetic disks such as internal hard disks and removable disks; magneto-optical disks; and CD-ROM and DVD-ROM disks. Non-volatile memory 506 may store various computer instructions including operating system instructions 512, communication instructions 514, application instructions 516, and application data 517. Operating system instructions 512 may include instructions for implementing an operating system (e.g., Mac OS®, Windows®, or Linux). The operating system may be multi-user, multiprocessing, multitasking, multithreading, real-time, and the like. Communication instructions 514 may include network communications instructions, for example, software for implementing communication protocols, such as TCP/IP, HTTP, Ethernet, telephony, etc. Application instructions 516 may include instructions for performing intelligent rolling updates on a cluster of servers according to the systems and methods disclosed herein. For example, application instructions 516 may include instructions for components 110-114 described above in conjunction with FIG. 1.

Peripherals 508 may be included within server device 500 or operatively coupled to communicate with server device 500. Peripherals 508 may include, for example, network subsystem 518, input controller 520, and disk controller 522. Network subsystem 518 may include, for example, an Ethernet of WiFi adapter. Input controller 520 may be any known input device technology, including but not limited to a keyboard (including a virtual keyboard), mouse, track ball, and touch-sensitive pad or display. Disk controller 522 may include one or more mass storage devices for storing data files; such devices include magnetic disks, such as internal hard disks and removable disks; magneto-optical disks; and optical disks.

FIG. 6 shows an example computing device 600, according to an embodiment of the present disclosure. In some embodiments, computing device 600 may be a client device 102 or customer support agent device 104. The illustrative computing device 600 may include a memory interface 602, one or more data processors, image processors, central processing units 604, and/or secure processing units 605, and peripherals subsystem 606. Memory interface 602, one or more processors 604 and/or secure processors 605, and/or peripherals subsystem 606 may be separate components or may be integrated in one or more integrated circuits. The various components in computing device 600 may be coupled by one or more communication buses or signal lines.

Sensors, devices, and subsystems may be coupled to peripherals subsystem 606 to facilitate multiple functionalities. For example, motion sensor 610, light sensor 612, and proximity sensor 614 may be coupled to peripherals subsystem 606 to facilitate orientation, lighting, and proximity functions. Other sensors 616 may also be connected to peripherals subsystem 606, such as a global navigation satellite system (GNSS) (e.g., GPS receiver), a temperature sensor, a biometric sensor, magnetometer, or other sensing device, to facilitate related functionalities.

Camera subsystem 620 and optical sensor 622, e.g., a charged coupled device (CCD) or a complementary metal-oxide semiconductor (CMOS) optical sensor, may be utilized to facilitate camera functions, such as recording photographs and video clips. Camera subsystem 620 and optical sensor 622 may be used to collect images of a user to be used during authentication of a user, e.g., by performing facial recognition analysis.

Communication functions may be facilitated through one or more wired and/or wireless communication subsystems 624, which can include radio frequency receivers and transmitters and/or optical (e.g., infrared) receivers and transmitters. For example, the Bluetooth (e.g., Bluetooth low energy (BTLE)) and/or WiFi communications described herein may be handled by wireless communication subsystems 624. The specific design and implementation of communication subsystems 624 may depend on the communication network(s) over which the computing device 600 is intended to operate. For example, computing device 600 may include communication subsystems 624 designed to operate over a GSM network, a GPRS network, an EDGE network, a WiFi or WiMax network, and a Bluetooth™ network. For example, wireless communication subsystems 624 may include hosting protocols such that computing device 600 can be configured as a base station for other wireless devices and/or to provide a WiFi service.

Audio subsystem 626 may be coupled to speaker 628 and microphone 630 to facilitate voice-enabled functions, such as speaker recognition, voice replication, digital recording, and telephony functions. Audio subsystem 626 may be configured to facilitate processing voice commands, voice-printing, and voice authentication, for example.

I/O subsystem 640 may include a touch-surface controller 642 and/or other input controller(s) 644. Touch-surface controller 642 may be coupled to a touch surface 646. Touch-surface 646 and touch-surface controller 642 may, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch surface 646.

The other input controller(s) 644 may be coupled to other input/control devices 648, such as one or more buttons, rocker switches, thumb-wheel, infrared port, USB port, and/or a pointer device such as a stylus. The one or more buttons (not shown) may include an up/down button for volume control of speaker 628 and/or microphone 630.

In some implementations, a pressing of the button for a first duration may disengage a lock of touch-surface 646; and a pressing of the button for a second duration that is longer than the first duration may turn power to computing device 600 on or off. Pressing the button for a third duration may activate a voice control, or voice command, module that enables the user to speak commands into microphone 630 to cause the device to execute the spoken command. The user may customize a functionality of one or more of the buttons. Touch-surface 646 can, for example, also be used to implement virtual or soft buttons and/or a keyboard.

In some implementations, computing device 600 may present recorded audio and/or video files, such as MP3, AAC, and MPEG files. In some implementations, computing device 600 may include the functionality of an MP3 player, such as an iPod™. Computing device 600 may, therefore, include a 36-pin connector and/or 8-pin connector that is compatible with the iPod. Other input/output and control devices may also be used.

Memory interface 602 may be coupled to memory 650. Memory 650 may include high-speed random access memory and/or non-volatile memory, such as one or more magnetic disk storage devices, one or more optical storage devices, and/or flash memory (e.g., NAND, NOR). Memory 650 may store an operating system 652, such as Darwin, RTXC, LINUX, UNIX, OS X, Windows, or an embedded operating system such as VxWorks.

Operating system 652 may include instructions for handling basic system services and for performing hardware dependent tasks. In some implementations, operating system 652 may be a kernel (e.g., UNIX kernel). In some implementations, operating system 652 may include instructions for performing voice authentication.

Memory 650 may also store communication instructions 654 to facilitate communicating with one or more additional devices, one or more computers and/or one or more servers. Memory 650 may include graphical user interface instructions 656 to facilitate graphic user interface processing; sensor processing instructions 658 to facilitate sensor-related processing and functions; phone instructions 660 to facilitate phone-related processes and functions; electronic messaging instructions 662 to facilitate electronic messaging-related process and functions; web browsing instructions 664 to facilitate web browsing-related processes and functions; media processing instructions 666 to facilitate media processing-related functions and processes; GNSS/Navigation instructions 668 to facilitate GNSS and navigation-related processes and instructions; and/or camera instructions 670 to facilitate camera-related processes and functions.

Memory 650 may store application (or “app”) instructions and data 672, such as instructions for the apps described above in the context of FIG. 3. Memory 650 may also store other software instructions 674 for various other software applications in place on device 600.

Each of the above identified instructions and applications may correspond to a set of instructions for performing one or more functions described herein. These instructions need not be implemented as separate software programs, procedures, or modules. Memory 650 may include additional instructions or fewer instructions. Furthermore, various functions of device 600 may be implemented in hardware and/or in software, including in one or more signal processing and/or application specific integrated circuits.

In some embodiments, processor(s) 604 may perform processing including executing instructions stored in memory 650, and secure processor 605 may perform some processing in a secure environment that may be inaccessible to other components of device 600. For example, secure processor 605 may include cryptographic algorithms on board, hardware encryption, and physical tamper proofing. Secure processor 605 may be manufactured in secure facilities. Secure processor 605 may encrypt data/challenges from external devices. Secure processor 605 may encrypt entire data packages that may be sent from device 600 to the network. Secure processor 605 may separate a valid user/external device from a spoofed one, since a hacked or spoofed device may not have the private keys necessary to encrypt/decrypt, hash, or digitally sign data, as described herein.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a customer support agent, the features may be implemented on a computer having a display device such as an LED or LCD monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A method for generating improved search results comprising:
receiving, by at least one processor, an inquiry associated with an interaction between a customer and a customer support agent from a device associated with a customer support agent;
entering, by the at least one processor, the inquiry as an input to a contextual bandit model;
selecting, using the contextual bandit model, a collection of articles from a plurality of pre-defined collections of articles based on the inquiry;
causing, by the at least one processor and in response to the contextual bandit model selecting the collection of articles, at least one search result to be displayed on a user interface of the device associated with the customer support agent, wherein a search result includes at least a portion of at least one article of the collection of articles;
causing, by the at least one processor, text within the at least one search result to be highlighted;
receiving, by the at least one processor, feedback on the collection of articles from the customer support agent; and
updating, by the at least one processor, the contextual bandit model based on the feedback.

2. The method of claim 1 comprising causing, by the at least one processor, the at least one search result to be displayed on a user interface in an order, wherein the order is based on a relevance score.

3. The method of claim 1, wherein the contextual bandit model is configured to select a random collection of articles after a pre-defined number of selections have been made.

4. The method of claim 1, wherein the portion of the at least one article that is displayed contains more highlighted text than any other portion within the at least one article.

5. The method of claim 1, wherein receiving feedback comprises receiving a scalar number from the customer support agent.

6. The method of claim 1, wherein receiving feedback comprises:
recording each action the customer support agent performs in response to the device associated with the customer support agent displaying the at least one search result; and
receiving feedback associated with the action.

7. The method of claim 6 comprising:
in response to recording the customer support agent send a complete search result of the at least one search result to the customer, receiving a high reward;
in response to recording the customer support agent send a part of a search result of the at least one search result to the customer, receiving a medium reward; and
in response to recording the customer support agent send a message to the customer that does not include any content from the at least one search result, receiving a low reward.

8. The method of claim 1 comprising:
processing the inquiry to map the inquiry to a vector representation; and
entering the processed inquiry as an input to the contextual bandit model.

9. The method of claim 8, wherein processing comprises using a skip-gram algorithm.

10. The method of claim 1, wherein the text to be highlighted is determined using a Latent Dirichlet Allocation based model.

11. The method of claim 1, wherein the text to be highlighted is determined using a Siamese network binary classifier.

12. The method of claim 1 comprising:
entering, by the at least one processor, a chat history as an input to the contextual bandit model; and
selecting, using the contextual bandit model, a collection of articles from a plurality of pre-defined collections of articles based on the inquiry and the chat history.

13. A method for generating improved search results comprising:
receiving, by at least one processor, an inquiry from a client device;
processing, by the at least one processor, the inquiry to map the inquiry to a vector representation;
sending, by the at least one processor, the processed inquiry to a server, wherein the server comprises a contextual bandit model;
receiving, from the server, instructions to display, by the at least one processor and in response to the contextual bandit model selecting, based on the processed inquiry, a collection of articles from a plurality of collection of articles, at least one search result, wherein a search result includes at least a portion of at least one article of the collection of articles on a user interface;
receiving, from the server, instructions to display, by the at least one processor, highlighted text within the at least one search result;
displaying the at least one search result; and
sending, by the at least one processor, feedback on the selected collection of articles from the customer support agent.

14. The method of claim 13, wherein the portion of the at least one article that is displayed contains more highlighted text than any other portion within the at least one article.

15. The method of claim 13, wherein processing comprises using a skip-gram algorithm.

16. The method of claim 13, wherein the text highlighted is determined using one of a Latent Dirichlet Allocation based model and a Siamese network binary classifier.

17. The method of claim 13 comprising sending, by the at least one processor, a chat history to the server as an input to the contextual bandit model.

18. The method of claim 13 comprising:
providing, by the user interface, functionality for the customer support agent to compose a message to send to the customer, wherein the message includes least one of free form text or text from a search result of the at least one search result; and
receiving, by the at least one processor, a command to compose the message.

19. The method of claim 18 comprising:
providing, by the user interface, functionality for the customer support agent to save the message; and
receiving, by the at least one processor, a command to save the message.

20. A system for generating improved search results comprising:
a client device associated with a customer;
a customer support agent device associated with a customer support agent configured to communicate with the client device;
a server comprising at least one processor;
a contextual bandit model executed by the at least one processor and configured to:
receive, as an input, an inquiry associated with an interaction between a customer and a customer support agent;
select, based on the inquiry, a collection of articles from a plurality of pre-defined collections of articles; and
determine that the inquiry does not correspond to any collection of articles within the plurality of collections of articles; and
a non-transitory, computer-readable medium comprising instructions thereon which, when executed by the at least one processor, cause the at least one processor to execute a process operable to:
receive, by at least one processor, the inquiry associated with an interaction between a customer and a customer support agent from a device associated with a customer support agent;
enter, by the at least one processor, the inquiry as the input to the contextual bandit model;
cause, by the at least one processor and in response to the contextual bandit model selecting the collection of articles, at least one search result to be displayed on a user interface of the device associated with the customer support agent, wherein a search result includes at least a portion of at least one article of the collection of articles;
cause, in response to the contextual bandit model determining that the inquiry does not correspond to any collection of articles within the plurality of collections of articles, a random question to be displayed on the user interface;
receive, by the at least one processor, feedback on the collection of articles from the customer support agent; and
update, by the at least one processor, the contextual bandit model based on the feedback.
